(19) United States
(12) Patent Application Publication
(10) Pub. No.: US 2003/0073759 A1
(43) Pub. Date: Apr. 17, 2003

(54) Water base ink for ink-jet recording

(75) Inventors: Narumi Koga, Nagoya-shi (JP); Kazuma Goto, Nagoya-shi (JP); Naomichi Kobayashi, Nagoya-shi (JP); Michiko Aoyama, Nagoya-shi (JP); Shunichi Higashiyama, Yotsukaichi-shi (JP); Masaya Fujioka, Nagoya-shi (JP)

Correspondence Address: OLIFF & BERRIDGE, PLC, P.O. BOX 19928, ALEXANDRIA, VA, 22320, US

(73) Assignee: BROTHER KOGYO KABUSHIKI KAISHA, Nagoya-shi (JP)

(21) Appl. No.: 10/097,411

(22) Filed: Mar. 15, 2002

(30) Foreign Application Priority Data
Mar. 29, 2001 (JP) 2001-097015

(51) Int. Cl. C03C 17/00

(52) U.S. Cl. 523/160

(57) ABSTRACT

An ink for ink-jet recording comprises water; a coloring agent; an acetylene glycol/ethylene oxide adduct; and first and second polyoxyalkylene glycol-n-alkyl ethers which are different from each other. The first polyoxyalkylene glycol-n-alkyl ether is polypropylene glycol-n-butyl ether having three or more propylene oxides. Even when the recording is performed on regular paper, the color bleed is suppressed.

### BACKGROUND OF THE INVENTION

1. Field of the Invention

The present invention relates to a water base ink for recording to be used for an ink-jet printer, and specifically relates to the water base ink with which color bleed can be reduced.

2. Description of the Related Art

The ink discharge system, which has been hitherto known for the ink-jet recording system, includes, for example, the electrostatic attraction system, the system in which mechanical vibration or displacement is applied to the ink by using a piezoelectric element or the like, and the method in which bubbles are generated by heating the ink to utilize the pressure generated thereby. Ink droplets are formed by means of the discharge system as described above, and all or a part of the droplets are adhered to a recording objective such as paper to perform the recording. Those known and used as the ink to be employed for the ink-jet recording system as described above include those in which a variety of water-soluble dyes or pigments are dissolved or dispersed in liquid media each comprising water or a combination of water and water-soluble organic solvent.

In order to adequately perform the recording for a long period of time by using the ink as described above, for example, the following conditions are required. That is, the characteristic values including, for example, the viscosity, the surface tension, the electric conductivity, and the density of the ink to be used are appropriate values. In order to avoid any clog-up at the nozzle or the orifice of the recording apparatus, no deposited matter is generated and no physical property value is changed by the influence of heat or the like. Further, the recorded image is excellent, for example, in water resistance and light resistance. A large number of suggestions have been made in order to satisfy the conditions as described above.

However, in recent years, it is more demanded to perform the recording on the regular paper rather than on the exclusive ink-jet paper in view of the cost and the consideration of the environment. In the case of most of the conventional inks, when the recording is performed on the regular paper, the following problem arises. That is, the color bleed is apt to occur, which is caused such that the inks of different colors are mixed with each other at portions at which the different colors are adjacent to one another.

U.S. Pat. No. 5,734,403 corresponding to Japanese Patent Application Laid-Open No. 6-136309 discloses addition of ethylene oxide adducts of acetylene glycol to an ink in order to impart penetrability to the color ink.

Japanese Patent Application Laid-Open No. 2001-10033 discloses a yellow organic pigment ink composition comprising C. I. Pigment Yellow 128, a water-soluble resin based on styrene-(meth)acrylic acid, an acetylene glycol compound (surfactant), triethylene glycol monobutyl ether, glycerol, and a water-soluble organic solvent. This document discloses a structure of ethylene oxide adduct as the acetylene glycol compound.

Japanese Patent Application Laid-Open No. 8-283631 discloses an ink-jet recording ink comprising at least (A) a water-soluble dye, (B) propylene glycol mono-n-butyl ether and/or dipropylene glycol mono-n-butyl ether, (C) an acetylene glycol-based surfactant, and (D) water.

Japanese Patent Application Laid-Open No. 2000-265096 discloses an ink composition for ink-jet recording, comprising at least a pigment, a dispersing agent, and water. This composition further comprises (a) fine polymer particles, (b) triethylene glycol butyl ether, (c) a water-soluble organic solvent selected from the group consisting of ethylene glycol, diethylene glycol, and glycerol, and (d) a water-soluble compound having two or three hydroxyl groups bonded to hydrocarbon having a number of carbons of 4 to 6.

### SUMMARY OF THE INVENTION

The present invention has been made in order to solve the problems as described above, an object of which is to provide a water base ink for ink-jet recording with which the color bleed is reduced even when the ink is used for recording on the regular paper.

According to the present invention, there is provided an ink for ink-jet recording comprising:

water;

a coloring agent; and

an acetylene glycol/ethylene oxide adduct represented by the following formula:

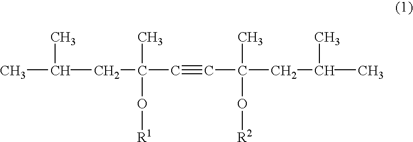

R¹=(CH₂CH₂O)ₘH

R²=(CH₂CH₂O)ₙH

m+n=2˜12

the ink further comprising first and second polyoxyalkylene glycol-n-alkyl ethers which are different from each other, wherein:

the first polyoxyalkylene glycol-n-alkyl ether is polypropylene glycol-n-butyl ether having three or more propylene oxides.

In this specification, the polyoxyalkylene glycol-n-alkyl ether also includes monooxyalkylene glycol-n-alkyl ether having one oxyalkylene group.

The water base ink for ink-jet recording of the present invention contains at least water and the coloring agent. The water to be used in the present invention is not specifically limited. However, it is preferable to use water having high purity such as ion exchange water and distilled water, rather than the use of ordinary water such as tap water. The content of the water may be determined depending on the type and the composition of the coloring agent and the polyoxyalkylene glycol-n-alkyl ether or the characteristics of the desired ink. However, in general, it is preferable that the content is 10 to 98% by weight with respect to the total weight of the ink. If the content is less than 10% by weight, or if the content exceeds 98% by weight, then it is difficult that the viscosity of the ink in the ordinary state is maintained to be a viscosity at which the ink can be normally jetted. The content is more preferably 30 to 97% by weight, and much more preferably 40 to 95% by weight.

Those usable as the coloring agent to be used in the present invention include, for example, dyes and pigments. Those usable as the dye include, for example, water-soluble dyes represented by direct dye, acidic dye, basic dye, and reactive dye.

The water-soluble dye is not specifically limited. However, it is preferable to use those which are adequate for the ink to be used for the ink-jet recording system and which satisfy required performance such as vividness, water solubility, stability, light resistance, and other required performance, including, for example, C. I. Direct Black 17, 19, 32, 51, 71, 108, 146, 154, 168; C. I. Direct Blue 6, 22, 25, 71, 86, 90, 106, 199; C. I. Direct Red 1, 4, 17, 28, 83, 227; C. I. Direct Yellow 12, 24, 26, 86, 98, 132, 142; C. I. Direct orange 34, 39, 44, 46, 60; C. I. Direct Violet 47, 48; C. I. Direct Brown 109; C. I. Direct Green 59; C. I. Acid Black 2, 7, 24, 26, 31, 52, 63, 112, 118; C. I. Acid Blue 9, 22, 40, 59, 93, 102, 104, 113, 117, 120, 167, 229, 234; C. I. Acid Red 1, 6, 32, 37, 51, 52, 80, 85, 87, 92, 94, 115, 181, 256, 289, 315, 317; C. I. Acid Yellow 11, 17, 23, 25, 29, 42, 61, 71; C. I. Acid Orange 7, 19; C. I. Acid Violet 49; C. I. Basic Black 2; C. I. Basic Blue 1, 3, 5, 7, 9, 24, 25, 26, 28, 29; C. I. Basic Red 1, 2, 9, 12, 13, 14, 37; C. I. Basic Violet 7, 14, 27; and C. I. Food Black 1, 2.

The pigment is not specifically limited provided that the pigment is capable of being dispersed in the aqueous phase. The pigment includes, for example, azo pigment such as azo lake, insoluble azo pigment, condensed azo pigment, and chelate azo pigment; polycyclic pigment such as phthalocyanine pigment, perylene, perynone pigment, anthraquinone pigment, quinacridone pigment, dioxazine pigment, thioindigo pigment, isoindolinone pigment, and quinophthalone pigment; dye lake such as basic dye type lake and acidic dye type lake; organic pigment such as nitro pigment, nitroso pigment, and aniline black daylight fluorescent pigment; and inorganic pigment such as titanium oxide, iron oxide-based pigment, and carbon black-based pigment. For example, those obtained by applying a surface treatment to the various pigments described above, for example, with a surfactant or a macromolecular dispersing agent can be also used as the pigment to be used in the present invention. Such a material includes, for example, graft carbon.

When the pigment as described above is used as the coloring agent to be used in the present invention, a dispersing treatment is performed in accordance with a conventionally known method together with an appropriate dispersing agent, a solvent, pure water, and optionally other additives. Those usable as the dispersing agent include, for example, a surfactant and a macromolecular dispersing agent to be used to disperse the pigment as described in Japanese Patent Application Laid-Open No. 62-101672.

The macromolecular dispersing agent is not specifically limited, including, for example, protein such as gelatin and albumin; natural rubber such as gum arabic and gum traganth; glucoside such as saponin; cellulose derivative such as methyl cellulose, carboxy cellulose, and hydroxymethyl cellulose; natural macromolecule such as lignosulfonate and shellac; anionic macromolecule such as salt of polyacrylic acid, salt of styrene-acrylic acid copolymer, salt of vinylnaphthalene-acrylic acid copolymer, salt of styrene-maleic acid copolymer, salt of vinylnaphthalene-maleic acid copolymer, and sodium salt and phosphoric acid salt of β-naphthalenesulfonic acid-formalin condensate; and nonionic macromolecule such as polyvinyl alcohol, polyvinyl pyrrolidone, and polyethylene glycol.

The surfactant includes, for example, anionic surfactant such as higher alcohol sulfuric acid ester salt, liquid fatty oil sulfuric acid ester salt, and alkylarylsulfonic acid salt; and nonionic surfactant such as polyoxyethylene alky ether, polyoxyethylene alkyl ester, sorbitan alkyl ester, and polyoxyethylene sorbitan alkyl ester. The dispersing agent may be used singly, or two or more of the dispersing agents may be used in combination.

It is preferable that the dispersing agent is generally blended in an amount of 0.01 to 20% by weight with respect to the total weight of the ink. If the blending amount is less than 0.01% by weight, or if the blending amount exceeds 20% by weight, then the dispersion stability of the pigment is insufficient, sometimes resulting in destruction of dispersion such as aggregation and sedimentation of the pigment.

The dispersing machine, which is used for the dispersing treatment for the pigment as described above, is not specifically limited. It is possible to widely use general dispersing machines. However, the dispersing machine includes, for example, ball mills, roll mills, and sand mills. Especially, it is preferable to use a high speed type sand mill.

The dye and the pigment may be used singly respectively. Alternatively, two or more dyes, two or more pigments, or two or more dyes and pigments may be mixed and used. It is preferable that the content of the coloring agent is generally 0.1 to 20% by weight with respect to the total weight of the ink. If the content is less than 0.1% by weight, it is difficult to obtain a sufficient printing density. If the content exceeds 20% by weight, then the dye fails to be sufficiently dissolved in the solvent resulting in deposition in some cases, and the pigment hardly maintains the dispersion stability. The content is more preferably 0.3 to 1.5% by weight, and much more preferably 0.5 to 10% by weight.

The water base ink for ink-jet recording according to the present invention further comprises the acetylene glycol/ethylene oxide adduct and two or more of the polyoxyalkylene glycol-n-alkyl ethers.

The acetylene glycol/ethylene oxide adduct to be used for the present invention is not specifically limited, which includes, for example, the compound represented by the following general formula (1).

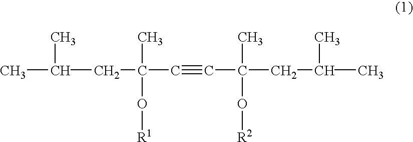

R¹=(CH₂CH₂O)ₘH

R²=(CH₂CH₂O)ₙH

m+n=2˜12

It is preferable that m+n=4 or m+n=10 is satisfied. The compound represented by the formula (1) is available as “Olfine E” from Nissin Chemical Industry and as “Surfynole” from Air Products and Chemicals Inc. respectively. Each of the products usually contains a plurality of compounds having different m and n, constituting a composition specified by (m+n).

The penetration of the ink into the recording paper is effectively quickened by containing the acetylene glycol/ethylene oxide adduct as described above in the water base ink for ink-jet recording of the present invention. It is preferable that the content of the acetylene glycol/ethylene oxide adduct is 0.01 to 10% by weight with respect to the total weight of the ink. If the content is less than 0.01% by weight, it is impossible to obtain any sufficient penetrating function into the recording paper. If the content exceeds 10% by weight, it is difficult to maintain the surface tension of the ink in the ordinary state at an appropriate value at which the ink can be normally jetted. More preferably, the content is 0.1 to 1% by weight.

It is preferable for the polyoxyalkylene glycol-n-alkyl ether to be used in the present invention that the number of carbon or carbons of the alkyl group is not more than 5, and the number of carbon or carbons of the oxyalkylene group is not more than 12. Those having a long molecular chain result in extreme increase in viscosity, which are not suitable for the material for the water base ink for ink-jet recording. The polyoxyalkylene glycol-n-alkyl ether functions as a penetrating agent to avoid the color bleed.

The polyoxyalkylene glycol-n-alkyl ether includes glycol ethers represented by alkyl ethers based on ethylene glycol and propylene glycol. The compound based on ethylene glycol includes, for example, ethylene glycol-n-methyl ether, ethylene glycol-n-ethyl ether, ethylene glycol-n-propyl ether, ethylene glycol-n-butyl ether, ethylene glycol-n-isobutyl ether, diethylene glycol-n-methyl ether, diethylene glycol-n-ethyl ether, diethylene glycol-n-propyl ether, diethylene glycol-n-butyl ether, diethylene glycol-n-isobutyl ether, triethylene glycol-n-methyl ether, triethylene glycol-n-ethyl ether, triethylene glycol-n-propyl ether, triethylene glycol-n-butyl ether, and triethylene glycol-n-isobutyl ether.

The compound based on propylene glycol includes, for example, propylene glycol-n-methyl ether, propylene glycol-n-ethyl ether, propylene glycol-n-propyl ether, propylene glycol-n-isopropyl ether, propylene glycol-n-butyl ether, dipropylene glycol-n-methyl ether, dipropylene glycol-n-ethyl ether, dipropylene glycol-n-propyl ether, dipropylene glycol-n-isopropyl ether, dipropylene glycol-n-butyl ether, tripropylene glycol-n-methyl ether, tripropylene glycol-n-ethyl ether, tripropylene glycol-n-propyl ether, tripropylene glycol-n-isopropyl ether, tripropylene glycol-n-butyl ether, tetrapropylene glycol-n-methyl ether, tetrapropylene glycol-n-ethyl ether, tetrapropylene glycol-n-propyl ether, tetrapropylene glycol-n-isopropyl ether, tetrapropylene glycol-n-butyl ether, pentapropylene glycol-n-methyl ether, pentapropylene glycol-n-ethyl ether, pentapropylene glycol-n-propyl ether, pentapropylene glycol-n-isopropyl ether, and pentapropylene glycol-n-butyl ether.

The present invention has such an essential feature that at least one of the polyoxyalkylene glycol-n-alkyl ethers is polypropylene glycol-n-butyl ether having three or more propylene oxides. The polypropylene glycol-n-butyl ether having three or more propylene oxides includes, for example, tripropylene glycol-n-butyl ether, tetrapropylene glycol-n-butyl ether, and pentapropylene glycol-n-butyl ether.

In the case of the water base ink for ink-jet recording of the present invention, the color bleed, which results from the slow-drying property on the recording paper, is effectively reduced owing to the fact that the polyoxyalkylene glycol-n-alkyl ether is contained.

It is impossible to effectively reduce the color bleed even when the polypropylene glycol-n-butyl ether having three or more propylene oxides is used singly. However, when the polypropylene glycol-n-butyl ether having three or more propylene oxides is added to the ink composition in combination with the acetylene glycol/ethylene oxide adduct and the another polyoxyalkylene glycol-n-alkyl ether as referred to above, it is possible to extremely effectively reduce the color bleed in which the inks of different colors are mixed with each other at portions at which the different colors are adjacent to one another, even when the recording is performed on the regular paper. The reason why the color bleed can be effectively reduced by using the acetylene glycol/ethylene oxide adduct, the another polyoxyalkylene glycol-n-alkyl ether, and the polypropylene glycol-n-monobutyl ether having three or more propylene oxides in combination is not distinct. However, it is possible to assume the reason to be as follows.

The polypropylene glycol-n-butyl ether having three or more propylene oxides especially has such a property that the polypropylene glycol-n-butyl ether having three or more propylene oxides tends to be localized at the interface between the ink and the air, among the polyoxyalkylene glycol-n-alkyl ethers. It is considered that the polypropylene glycol-n-butyl ether having three or more propylene oxides effectively quicken the penetration speed of the ink when the ink droplets are landed on the recording paper, as compared with a case in which another polyalkylene glycol-n-alkyl ether is used singly. The acetylene glycol/ethylene oxide adduct has high wettability, and hence the acetylene glycol/ethylene oxide adduct facilitates the penetration of the ink into the recording paper. It is considered that when the acetylene glycol/ethylene oxide adduct, the another polyoxyalkylene glycol-n-alkyl ether, and polypropylene glycol-n-butyl ether having three or more propylene oxides are simultaneously used, the penetration speed of the ink into the recording paper is synergistically quickened as compared with a case in which each of them is used singly.

That is, when the another polyoxyalkylene glycol-n-alkyl ether is used singly, then the polyoxyalkylene glycol-n-alkyl ether is not localized in the ink, and it exists in a uniformly dispersed state. Therefore, the another polyoxyalkylene glycol-n-alkyl ether has only an effect to evenly accelerate the penetrability of the ink. However, when the acetylene glycol/ethylene oxide adduct and the polypropylene glycol-n-butyl ether having three or more propylene oxides are additionally used in combination, the polypropylene glycol-n-butyl ether having three or more propylene oxides and the acetylene glycol/ethylene oxide adduct are uniformly localized at the outermost surfaces of the ink droplets, in addition to the evenly penetrating effect of the polyoxyalkylene glycol-n-alkyl ether. Accordingly, it is considered that the penetration speed at the earliest stage is quickened at the moment at which the ink droplets are landed on the recording paper.

The polypropylene glycol-n-butyl ether having three or more propylene oxides effectively quicken the penetration speed of the ink when the ink droplets are landed on the recording paper as described above. However, it is difficult to add a large amount of the polypropylene glycol-n-butyl ether having three or more propylene oxides to the water base ink, because the solubility thereof in water is not large. Therefore, the effective penetrating function into the recording paper is scarcely obtained when the polypropylene glycol-n-butyl ether having three or more propylene oxides is used singly.

Further, the excellent effect to reduce the color bleed is not sufficiently obtained, for example, even when an ordinary surfactant is used in place of the polypropylene glycol-n-butyl ether having three or more propylene oxides. It is considered that this fact results from that the molecule of the polypropylene glycol-n-butyl ether having three or more propylene oxides is small as compared with the ordinary surfactant, and the movement speed to arrive at the outermost surfaces of the ink droplets is sufficiently fast. It is speculated that the similarity of the structures of the another polyoxyalkylene glycol-n-alkyl ether and the polypropylene glycol-n-butyl ether having three or more propylene oxides also serves as a factor necessary for the ink droplets to advance the penetration into the recording paper continuously and smoothly starting from the outermost surfaces of the ink droplets and continuing to the inside thereof.

It is preferable that the total content of the polyoxyalkylene glycol-n-alkyl ether is 2 to 15% by weight with respect to the total weight of the ink. If the total content is less than 2% by weight, then the penetration speed of the ink into the recording paper is slow, the drying time is long, and any problem arises in color bleed in some cases. On the other hand, if the total content exceeds 15% by weight, then the penetration of the ink into the recording paper is vigorous, and the ink arrives at the back of the recording paper in some cases, or any problem also arises in feathering as a phenomenon in which the ink causes any blur like moustache or whiskers along fibers of the paper in other cases. More preferably, the total content is 3 to 12% by weight. Much more preferably, the total content is 4 to 10% by weight.

The blending ratio between the polypropylene glycol-n-butyl ether having three or more propylene oxides and the another polyoxyalkylene glycol-n-alkyl ether is determined within a wide range depending on the composition or the characteristics of the desired ink. In general, it is preferable that the rate occupied by the polypropylene glycol-n-butyl ether having three or more propylene oxides is 1 to 80% by weight with respect to the total content of the polyoxyalkylene glycol-n-alkyl ethers. If the rate is less than 1% by weight, it is difficult to obtain the effective penetrating function into the recording paper. If the rate exceeds 80% by weight, then the polypropylene glycol-n-butyl ether is not sufficiently dissolved in the ink, and it is difficult to obtain the effective penetrating function, because the solubility of the polypropylene glycol-n-butyl ether in water is not large. More preferably, the rate is 3 to 60% by weight. Much more preferably, the rate is 5 to 50% by weight.

Additionally, the water base ink for ink-jet recording of the present invention may optionally contain, for example, hitherto known various types of dispersing agents, surfactants, viscosity-adjusting agents, surface tension-adjusting agents, pH-adjusting agents, antiseptic agents, and fungicides.

The water base ink for ink-jet recording of the present invention may further contain the following compounds, for example, in order to improve the liquid stability of the ink. Such compounds include, for example, polyhydric alcohol such as ethylene glycol, diethylene glycol, triethylene glycol, polyethylene glycol, propylene glycol, dipropylene glycol, tripropylene glycol, polypropylene glycol, 1,3-butanediol, 1,5-pentanediol, 1,6-hexanediol, glycerol, 1,2,6-hexanetriol, 1,2,4-butanetriol, 1,2,3-butanetriol, and pentanetriol; nitrogen-containing heterocyclic compound such as N-methyl-2-pyrrolidone, N-hydroxyethyl-2-pyrrolidone, 2-pyrrolidone, 1,3-dimethylimidazolidinone, and ε-caprolactam; amide such as formamide, N-methylformamide, and N,N-dimethylformamide; amine such as monoethanolamine, diethanolamine, triethanolamine, monoethylamine, diethylamine, and triethylamine; and sulfur-containing compound such as dimethylsulfoxide, sulfolane, and thiodiethanol. Each of the compounds may be used singly, or two or more of them may be used in combination.

The compound as described above has a drying-preventive (humidifying or wetting) effect on the ink at the nozzle of the head of the ink-jet printer. The content of the compound as described above is determined within a wide range depending on the composition of the ink or the characteristics of the desired ink. However, in general, the content is preferably 0 to 40% by weight. If the content exceeds 40% by weight, for example, problems arise in some cases such that the viscosity of the ink is unnecessarily increased to make it impossible to discharge the ink, or the ink is dried extremely slowly on the recording paper. More preferably, the content is 5 to 30% by weight.

When the water base ink for ink-jet recording of the present invention is used for the ink-jet recording method of the type in which the recording liquid is electrically charged, it is also preferable to contain specific resistance-adjusting agents including, for example, inorganic salts such as lithium chloride, ammonium chloride, and sodium chloride.

Further, when the water base ink for ink-jet recording of the present invention is used for the ink-jet system of the type in which the ink is discharged in accordance with the action of the thermal energy, for example, it is also preferable to adjust values of thermal physical properties including, for example, the specific heat, the coefficient of thermal expansion, and the coefficient of thermal conductivity.

The problems involved in the conventional technique are sufficiently solved in the water base ink for ink-jet recording of the present invention obtained as described above. The color bleed is reduced in the ink-jet system. It is possible to provide the vivid color recording.

### DESCRIPTION OF THE PREFERRED EMBODIMENTS

The present invention will be explained in further detail below as exemplified by embodiments. However, the present invention is not limited to only the embodiments.

### EXAMPLES 1 TO 8 AND COMPARATIVE EXAMPLES 1 TO 8

Compositions of inks prepared in Examples 1 to 8 and Comparative Examples 1 to 8 respectively are shown in Tables 1 to 16. The acetylene glycol/ethylene oxide adduct (referred to as “acetylene glycol/EO adduct” in the tables) used in each of Examples and Comparative Examples described below is the compound having the structure represented by the formula (1). In the case of m+n=4, Olfine E 1004 produced by Nissin Chemical Industry was used. In the case of m+n=10, Olfine E 1010 produced by Nissin Chemical Industry was used.

TABLE 1

| Example 1 | Black | Cyan | Magenta | Yellow |
|---|---|---|---|---|
| Pure water | 72.9 | 75.9 | 75.9 | 75.9 |
| C. I. Direct Black 17 | 3 | — | — | — |
| C. I. Direct Black 108 | 3 | — | — | — |
| C. I. Direct Blue 90 | — | 3 | — | — |
| C. I. Direct Red 83 | — | — | 3 | — |
| C. I. Direct Yellow 98 | — | — | — | 3 |
| Acetylene glycol/EO adduct, | 0.1 | 0.1 | 0.1 | 0.1 |
| m + n = 4 | | | | |
| Tripropylene glycol-n-butyl ether | 1 | 1 | 1 | 1 |
| Triethylene glycol-n-butyl ether | 5 | 5 | 5 | 5 |
| Glycerol | 5 | 5 | 5 | 5 |
| Diethylene glycol | 10 | 10 | 10 | 10 |

TABLE 2

| Example 2 | Black | Cyan | Magenta | Yellow |
|---|---|---|---|---|
| Pure water | 66.7 | 68.7 | 68.7 | 68.7 |
| C. I. Direct Black 154 | 2 | — | — | — |
| C. I. Direct Black 19 | 2 | — | — | — |
| C. I. Direct Blue 199 | — | 2 | — | — |
| C. I. Direct Red 80 | — | — | 2 | — |
| C. I. Direct Yellow 142 | — | — | — | 2 |
| Acetylene glycol/EO adduct, | 0.3 | 0.3 | 0.3 | 0.3 |
| m + n = 10 | | | | |
| Tripropylene glycol-n-butyl ether | 3 | 3 | 3 | 3 |
| Triethylene glycol-n-butyl ether | 3 | 3 | 3 | 3 |
| Diethylene glycol-n-butyl ether | 3 | 3 | 3 | 3 |
| Glycerol | 10 | 10 | 10 | 10 |
| Diethylene glycol | 10 | 10 | 10 | 10 |

TABLE 3

| Example 3 | Black | Cyan | Magenta | Yellow |
|---|---|---|---|---|
| Pure water | 68.9 | 71.9 | 71.9 | 71.9 |
| C. I. Direct Black 17 | 3 | — | — | — |
| C. I. Direct Black 108 | 3 | — | — | — |
| C. I. Direct Blue 90 | — | 3 | — | — |
| C. I. Direct Red 83 | — | — | 3 | — |
| C. I. Direct Yellow 98 | — | — | — | 3 |
| Acetylene glycol/EO adduct, | 0.1 | 0.1 | 0.1 | 0.1 |
| m + n = 4 | | | | |
| Tripropylene glycol-n-butyl ether | 1 | 1 | 1 | 1 |
| Diethylene glycol-n-butyl ether | 9 | 9 | 9 | 9 |
| Glycerol | 5 | 5 | 5 | 5 |
| Diethylene glycol | 10 | 10 | 10 | 10 |

TABLE 4

| Example 4 | Black | Cyan | Magenta | Yellow |
|---|---|---|---|---|
| Pure water | 74.7 | 76.7 | 76.7 | 76.7 |
| C. I. Direct Black 154 | 2 | — | — | — |
| C. I. Direct Black 19 | 2 | — | — | — |
| C. I. Direct Blue 199 | — | 2 | — | — |
| C. I. Direct Red 80 | — | — | 2 | — |
| C. I. Direct Yellow 142 | — | — | — | 2 |
| Acetylene glycol/EO adduct, | 0.3 | 0.3 | 0.3 | 0.3 |
| m + n = 10 | | | | |
| Tripropylene glycol-n-butyl ether | 1 | 1 | 1 | 1 |
| Triethylene glycol-n-butyl ether | 5 | 5 | 5 | 5 |
| Glycerol | 5 | 5 | 5 | 5 |
| Diethylene glycol | 10 | 10 | 10 | 10 |

TABLE 5

| Example 5 | Black | Cyan | Magenta | Yellow |
|---|---|---|---|---|
| Pure water | 74 | 76 | 76 | +TC,28/ 76 |
| C. I. Direct Black 154 | 2 | — | — | — |
| C. I. Direct Black 19 | 2 | — | — | — |
| C. I. Direct Blue 199 | — | 2 | — | — |
| C. I. Direct Red 80 | — | — | 2 | — |
| C. I. Direct Yellow 142 | — | — | — | 2 |
| Acetylene glycol/EO adduct, | 1 | 1 | 1 | 1 |
| m + n = 10 | | | | |
| Tripropylene glycol-n-butyl ether | 3 | 3 | 3 | 3 |
| Triethylene glycol-n-butyl ether | 3 | 3 | 3 | 3 |
| Glycerol | 5 | 5 | 5 | 5 |
| Diethylene glycol | 10 | 10 | 10 | 10 |

TABLE 6

| Example 6 | Black | Cyan | Magenta | Yellow |
|---|---|---|---|---|
| Pure water | 74.7 | 76.7 | 76.7 | 76.7 |
| C. I. Direct Black 154 | 2 | — | — | — |
| C. I. Direct Black 19 | 2 | — | — | — |
| C. I. Direct Blue 199 | — | 2 | — | — |
| C. I. Direct Red 80 | — | — | 2 | — |
| C. I. Direct Yellow 142 | — | — | — | 2 |
| Acetylene glycol/EO adduct, | 0.3 | 0.3 | 0.3 | 0.3 |
| m + n = 10 | | | | |
| Tripropylene glycol-n-butyl ether | 3 | 3 | 3 | 3 |
| Propylene glycol-n-butyl ether | 3 | 3 | 3 | 3 |
| Glycerol | 5 | 5 | 5 | 5 |
| Diethylene glycol | 10 | 10 | 10 | 10 |

TABLE 7

| Example 7 | Black | Cyan | Magenta | Yellow |
|---|---|---|---|---|
| Pure water | 72.8 | 74.8 | 74.8 | 74.8 |
| C. I. Direct Black 154 | 2 | — | — | — |
| C. I. Direct Black 19 | 2 | — | — | — |
| C. I. Direct Blue 199 | — | 2 | — | — |
| C. I. Direct Red 80 | — | — | 2 | — |
| C. I. Direct Yellow 142 | — | — | — | 2 |
| Acetylene glycol/EO adduct, | 0.1 | 0.1 | 0.1 | 0.1 |
| m + n = 4 | | | | |
| Tripropylene glycol-n-butyl ether | 0.1 | 0.1 | 0.1 | 0.1 |
| Triethylene glycol-n-butyl ether | 3 | 3 | 3 | 3 |
| Glycerol | 10 | 10 | 10 | 10 |
| Diethylene glycol | 10 | 10 | 10 | 10 |

TABLE 8

| Example 8 | Black | Cyan | Magenta | Yellow |
|---|---|---|---|---|
| Pure water | 41.7 | 68.7 | 68.7 | 68.7 |
| CABOJET 300 (produced by Cabot) | 27 | — | — | — |
| C. I. Direct Black 19 | 2 | — | — | — |
| C. I. Direct Blue 199 | — | 2 | — | — |
| C. I. Direct Red 80 | — | — | 2 | — |
| C. I. Direct Yellow 142 | — | — | — | 2 |
| Acetylene glycol/EO adduct, | 0.3 | 0.3 | 0.3 | 0.3 |
| m + n = 10 | | | | |
| Tripropylene glycol-n-butyl ether | 3 | 3 | 3 | 3 |
| Triethylene glycol-n-butyl ether | 3 | 3 | 3 | 3 |
| Diethylene glycol-n-butyl ether | 3 | 3 | 3 | 3 |
| Glycerol | 10 | 10 | 10 | 10 |
| Diethylene glycol | 10 | 10 | 10 | 10 |

TABLE 9

| Comparative Example 1 | Black | Cyan | Magenta | Yellow |
|---|---|---|---|---|
| Pure water | 72.7 | 74.7 | 74.7 | 74.7 |
| C. I. Direct Black 154 | 2 | — | — | — |
| C. I. Direct Black 19 | 2 | — | — | — |
| C. I. Direct Blue 199 | — | 2 | — | — |
| C. I. Direct Red 80 | — | — | 2 | — |
| C. I. Direct Yellow 142 | — | — | — | 2 |
| Acetylene glycol/EO adduct, | 0.3 | 0.3 | 0.3 | 0.3 |
| m + n = 10 | | | | |
| Tripropylene glycol-n-butyl ether | 3 | 3 | 3 | 3 |
| Glycerol | 10 | 10 | 10 | 10 |
| Diethylene glycol | 10 | 10 | 10 | 10 |

TABLE 10

| Comparative Example 2 | Black | Cyan | Magenta | Yellow |
|---|---|---|---|---|
| Pure water | 72.7 | 74.7 | 74.7 | 74.7 |
| C. I. Direct Black 154 | 2 | — | — | — |
| C. I. Direct Black 19 | 2 | — | — | — |
| C. I. Direct Blue 199 | — | 2 | — | — |
| C. I. Direct Red 80 | — | — | 2 | — |
| C. I. Direct Yellow 142 | — | — | — | 2 |
| Acetylene glycol/EO adduct, | 0.3 | 0.3 | 0.3 | 0.3 |
| m + n = 10 | | | | |
| Diethyleneglycol-n-butyl ether | 3 | 3 | 3 | 3 |
| Glycerol | 10 | 10 | 10 | 10 |
| Diethylene glycol | 10 | 10 | 10 | 10 |

TABLE 11

| Comparative Example 3 | Black | Cyan | Magenta | Yellow |
|---|---|---|---|---|
| Pure water | 75 | 77 | 77 | 77 |
| C. I. Direct Black 154 | 2 | — | — | — |
| C. I. Direct Black 19 | 2 | — | — | — |
| C. I. Direct Blue 199 | — | 2 | — | — |
| C. I. Direct Red 80 | — | — | 2 | — |
| C. I. Direct Yellow 142 | — | — | — | 2 |
| Tripropylene glycol-n-butyl ether | 3 | 3 | 3 | 3 |
| Triethylene glycol-n-butyl ether | 3 | 3 | 3 | 3 |
| Glycerol | 5 | 5 | 5 | 5 |
| Diethylene glycol | 10 | 10 | 10 | 10 |

TABLE 12

| Comparative Example 4 | Black | Cyan | Magenta | Yellow |
|---|---|---|---|---|
| Pure water | 73 | 75 | 75 | 75 |
| C. I. Direct Black 154 | 2 | — | — | — |
| C. I. Direct Black 19 | 2 | — | — | — |
| C. I. Direct Blue 199 | — | 2 | — | — |
| C. I. Direct Red 80 | — | — | 2 | — |
| C. I. Direct Yellow 142 | — | — | — | 2 |
| Tripropylene glycol-n-butyl ether | 3 | 3 | 3 | 3 |
| Glycerol | 10 | 10 | 10 | 10 |
| Diethylene glycol | 10 | 10 | 10 | 10 |

TABLE 13

| Comparative Example 5 | Black | Cyan | Magenta | Yellow |
|---|---|---|---|---|
| Pure water | 95.9 | 97.9 | 97.9 | 97.9 |
| C.I. Direct Black 154 | 2 | — | — | — |
| C.I. Direct Black 19 | 2 | — | — | — |
| C.I. Direct Blue 199 | — | 2 | — | — |
| C.I. Direct Red 80 | — | — | 2 | — |
| C.I. Direct Yellow 142 | — | — | — | 2 |
| Acetylene glycol/EO adduct, | 0.1 | 0.1 | 0.1 | 0.1 |
| m + n = 4 | | | | |
| Glycerol | 10 | 10 | 10 | 10 |
| Diethylene glycol | 10 | 10 | 10 | 10 |

TABLE 14

| Comparative Example 6 | Black | Cyan | Magenta | Yellow |
|---|---|---|---|---|
| Pure water | 78 | 80 | 80 | 80 |
| C. I. Direct Black 154 | 2 | — | — | — |
| C. I. Direct Black 19 | 2 | — | — | — |
| C. I. Direct Blue 199 | — | 2 | — | — |
| C. I. Direct Red 80 | — | — | 2 | — |
| C. I. Direct Yellow 142 | — | — | — | 2 |
| Tripropylene glycol-n-butyl ether | 3 | 3 | 3 | 3 |
| Glycerol | 5 | 5 | 5 | 5 |
| Diethylene glycol | 10 | 10 | 10 | 10 |

TABLE 15

| Comparative Example 7 | Black | Cyan | Magenta | Yellow |
|---|---|---|---|---|
| Pure water | 73 | 75 | 75 | 75 |
| C. I. Direct Black 154 | 2 | — | — | — |
| C. I. Direct Black 19 | 2 | — | — | — |
| C. I. Direct Blue 199 | — | 2 | — | — |
| C. I. Direct Red 80 | — | — | 2 | — |
| C. I. Direct Yellow 142 | — | — | — | 2 |
| Triethylene glycol-n-butyl ether | 3 | 3 | 3 | 3 |
| Glycerol | 10 | 10 | 10 | 10 |
| Diethylene glycol | 10 | 10 | 10 | 10 |

TABLE 16

| Comparative Example 8 | Black | Cyan | Magenta | Yellow |
|---|---|---|---|---|
| Pure water | 45 | 72 | 72 | 72 |
| CABOJET 300 (produced by Cabot) | 27 | — | — | — |
| C. I. Direct Black 19 | 2 | — | — | — |
| C. I. Direct Blue 199 | — | 2 | — | — |
| C. I. Direct Red 80 | — | — | 2 | — |
| C. I. Direct Yellow 142 | — | — | — | 2 |
| Triethylene glycol-n-butyl ether | 3 | 3 | 3 | 3 |
| Diethylene glycol-n-butyl ether | 3 | 3 | 3 | 3 |
| Glycerol | 10 | 10 | 10 | 10 |
| Diethylene glycol | 10 | 10 | 10 | 10 |

The respective materials were sufficiently mixed and agitated for the inks of Examples 1 to 8 and Comparative Examples 1 to 8, followed by performing filtration with a membrane filter of 0.8 μm to use the obtained inks for the following evaluation.

The black ink, the cyan ink, the magenta ink, and the yellow ink were subjected to the recording by using MFC-7150C (ink-jet printer produced by BROTHER INDUSTRIES, LTD.). The recording was performed by combining the colors so that the inks having the two different colors formed the letter color and the background color respectively on recording samples. The evaluation was directed to the blur at the boundary at which the colors were mixed with each other and to the distinction of letters. Letters, which were recorded without any background of each of the colors, were used for a recording sample to serve as an evaluation standard. As for the dimension of the recorded letters, the letter size was set to 11 with Microsoft Word 97. The recording was performed on the regular paper (Xerox 4200) by using MFC-7150C. The recording was performed in the same manner as described above with the respective colors of the comparative inks.

Next, the method for evaluating the recording samples subjected to the recording will be described below. The evaluation criterion was based on the degree of blur of the letters with the background as compared with the letters with no background in accordance with visual evaluation. The evaluation criterion is as follows:

++: the color bleed is scarcely observed, and the equivalent vividness is obtained as compared with the letters with no background;

+: the color bleed is slightly generated as compared with the letters with no background, but the letters are sufficiently readable;

±: the color bleed is clearly generated as compared with the letters with no background, but the letters are readable; and

−: the color bleed is clearly generated as compared with the letters with no background, and the letters are difficult to be read as well. Tables 17 and 18 show results of the evaluation of the recording samples based on the use of the respective inks.

TABLE 17

| | Example | | | | | | | |
|---|---|---|---|---|---|---|---|---|
| | 1 | 2 | 3 | 4 | 5 | 6 | 7 | 8 |
| Black letter × yellow background | ++ | ++ | ++ | ++ | ++ | ++ | + | ++ |
| Black letter × magenta background | ++ | ++ | ++ | ++ | ++ | ++ | + | ++ |
| Black letter × cyan background | ++ | ++ | ++ | ++ | ++ | ++ | + | ++ |
| Yellow letter × black background | ++ | ++ | ++ | ++ | ++ | ++ | + | ++ |
| Yellow letter × magenta | ++ | ++ | ++ | ++ | ++ | ++ | ++ | ++ |
| background | | | | | | | | |
| Yellow letter × cyan background | ++ | ++ | ++ | ++ | ++ | ++ | ++ | ++ |
| Magenta letter × black background | ++ | ++ | ++ | ++ | ++ | ++ | + | ++ |
| Magenta letter × yellow | ++ | ++ | ++ | ++ | ++ | ++ | ++ | ++ |
| background | | | | | | | | |
| Magenta letter × cyan background | ++ | ++ | ++ | ++ | ++ | ++ | ++ | ++ |
| Cyan letter × black background | ++ | ++ | ++ | ++ | ++ | ++ | + | ++ |
| Cyan letter × yellow background | ++ | ++ | ++ | ++ | ++ | ++ | ++ | ++ |
| Cyan letter × magenta background | ++ | ++ | ++ | ++ | ++ | ++ | ++ | ++ |

TABLE 18

| | Comparative Example | | | | | | | |
|---|---|---|---|---|---|---|---|---|
| | 1 | 2 | 3 | 4 | 5 | 6 | 7 | 8 |
| Black letter × yellow background | ± | ± | ± | − | − | − | − | − |
| Black letter × magenta background | ± | ± | ± | − | − | − | − | − |
| Black letter × cyan background | ± | ± | ± | − | − | − | − | − |
| Yellow letter × black background | ± | ± | ± | − | − | − | − | − |
| Yellow letter × magenta | + | + | + | ± | ± | ± | − | − |
| background | | | | | | | | |
| Yellow letter × cyan background | + | + | + | ± | ± | ± | − | − |
| Magenta letter × black background | ± | ± | ± | − | − | − | − | − |
| Magenta letter × yellow | + | + | + | ± | ± | ± | − | − |
| background | | | | | | | | |
| Magenta letter × cyan background | + | + | + | ± | ± | ± | − | − |
| Cyan letter × black background | ± | ± | ± | − | − | − | − | − |
| Cyan letter × yellow background | + | + | + | ± | ± | ± | − | − |
| Cyan letter × magenta background | + | + | + | ± | ± | ± | − | − |

As shown in Table 17, the blur due to the color bleed was scarcely observed, and the excellent effect to reduce the color bleed was successfully obtained, when the water base inks for ink-jet recording of the present invention of Examples 1 to 8 were used. On the other hand, as shown in Table 18, the color bleed clearly appeared in Comparative Examples 1 to 8, and it was impossible to obtain any satisfactory printing quality.

The present invention has been constructed as described above. Therefore, according to the present invention, the color bleed is reduced, and it is possible to perform the vivid color recording.

What is claimed is:

1. An ink for ink-jet recording comprising:
water;
a coloring agent; and
an acetylene glycol/ethylene oxide adduct represented by the following formula: 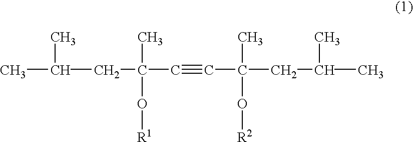
R¹=(CH₂CH₂O)ₘH
R²=(CH₂CH₂O)ₙH
m+n=2˜12
the ink further comprising first and second polyoxyalkylene glycol-n-alkyl ethers which are different from each other, wherein:
the first polyoxyalkylene glycol-n-alkyl ether is polypropylene glycol-n-butyl ether having three or more propylene oxides.

2. The ink according to claim 1, wherein m+n is 4 or 10 in the formula (1).

3. The ink according to claim 1, wherein the acetylene glycol/ethylene oxide adduct is contained by 0.01 to 10% by weight in the ink.

4. The ink according to claim 1, wherein the first polyoxyalkylene glycol-n-alkyl ether is tripropylene glycol-n-butyl ether.

5. The ink according to claim 1, wherein a total amount of the first and second polyoxyalkylene glycol-n-alkyl ethers is 2 to 15% by weight in the ink.

6. The ink according to claim 5, wherein the first polyoxyalkylene glycol-n-alkyl ether is contained by 1 to 80% by weight with respect to the total amount of the first and second polyoxyalkylene glycol-n-alkyl ethers.

7. The ink according to claim 1, wherein an alkyl group of the second polyoxyalkylene glycol-n-alkyl ether has a number of carbon or carbons of not more than 5, and an oxyalkylene group thereof has a number of carbon or carbons of not more than 12.

8. The ink according to claim 1, wherein the coloring agent includes black, cyan, magenta, and yellow coloring agents.
